(19) United States
(12) Patent Application Publication
(10) Pub. No.: US 2018/0111258 A1
(43) Pub. Date: Apr. 26, 2018

(54) GEAR ADJUSTING DEVICE FOR GEARBOX OF IMPACT DRILL

(71) Applicant: Best Achieve Industrial Limited, Dongguan City (CN)

(72) Inventors: Qiang WANG, Dongguan City (CN); Hsi-Jen JEN, Dongguan City (CN); Yi-Tung CHIU, Dongguan City (CN)

(21) Appl. No.: 15/333,996

(22) Filed: Oct. 25, 2016

(51) Int. Cl. B25D 16/00

(52) U.S. Cl. CPC B25D 16/006; B25D 2216/0084

(57) ABSTRACT

Disclosed is a gear adjusting device for a gearbox of an impact drill, comprising a front gearbox housing, a torsional cover, a reduction mechanism and a tripping mechanism which comprises annular adjusting screws, tripping columns and a tripping cushion. Each tripping column is sleeved with a compression spring with two ends respectively connected to the bottom of a corresponding adjusting screw and a corresponding tripping column. The torsional cover is in threaded drive connection with each adjusting screw. The lower end of each tripping column is connected with the reduction mechanism. The tripping cushion is slidably connected to the front gearbox housing along the vertical direction. A cushion locking structure is disposed between the torsional cover and the front gearbox housing. The tripping cushion can be locked and fixed by the cushion locking structure when the torsional cover is rotated anticlockwise, and then the tripping cushion cannot move vertically.

### BACKGROUND OF THE INVENTION

### Technical Field

The present invention relates to the technical field of impact drills, in particular to a gear adjusting device for a gearbox of an impact drill.

### 2. Description of Related Art

At present, an impact drill usually has several work modes. Those work modes are electric drilling, electric screw driving, and impact drilling, respectively. At a screw gear, the gear shift must be controlled to be adjusted to the screw gear. In such circumstances, the impact drill decides the time of tripping according to the torsion settings at the screw gear. During tripping, a rotating motor of the impact drill rotates continuously, but the screwdriver keeps still, so the impact drill fails to output the maximum torsion. At an electric drill gear, the rotating motor and a front drill bit keep the same actions to output the maximum torsion and maintain the gear without tripping. At an impact gear, except for the original functions of the electric drill gear, an impact mechanism will be enabled at the same time to play an impact role, and then the impact drill can bore holes on cement walls or other solid objects more efficiently. In order to perform operations and adjustment upon different needs, an impact switching device is usually designed between a rotating motor and a front component to meet the demands of mechanical operation and adjustment, and to supply a control interface for setting the impact drill by a user.

The gearbox gear structure of each of the existing impact gears is provided with a screw gear, an electric drill gear and an impact gear in turn along the direction in which the torsion increases, and the screw gear includes a plurality of torsion gears from the minimum torsion gear to the maximum torsion gear, wherein the electric drill gear is positioned next to the maximum torsion gear of the screw gear. During the gear adjustment process, when the gear shift is adjusted to the electric drill or impact function, the torsional cover is required to be adjusted from the minimum torsion gear to the maximum torsion gear of the screw gear, so the gear shift can be switched to the electric drill gear or the impact gear. The adjustment stroke is very large; the adjustment speed is low; the operation is complicated; and the efficiency is low.

### BRIEF SUMMARY OF THE INVENTION

The objective of the present invention is to provide a simply and conveniently operated gear adjusting device for an gearbox of an impact drill which can quickly adjust the gear shift to an electric drill gear or an impact gear to overcome the defects in the prior art.

To fulfill the above objective, the present invention adopts the following scheme. A gear adjusting device for a gearbox of an impact drill includes a front gearbox housing, a torsional cover rotationally sleeved at the top of the front gearbox housing, a reduction mechanism disposed at the bottom of the front gearbox housing and a tripping mechanism. The tripping mechanism includes annular adjusting screws which are sleeved on the front gearbox housing in a sliding way along the vertical direction, a plurality of tripping columns which are connected to the front gearbox housing in a sliding way along the vertical direction, and a tripping cushion positioned above the adjusting screws and the tripping columns. Each tripping column is sleeved with a compression spring; two ends of each compression spring are respectively connected to the bottom of each corresponding adjusting screw and each corresponding tripping column. External screw threads are formed on the outside surface of each adjusting screw; internal screw threads are formed on the inside surface of the torsional cover; and the internal screw threads of the torsional cover are in threaded drive connection with the external screw threads of each adjusting screw. The lower end of each tripping column is connected with the reduction mechanism. The tripping cushion is connected to the front gearbox housing in a sliding way along the vertical direction. A cushion locking structure capable of locking the tripping cushion is disposed between the torsional cover and the front gearbox housing. When the torsional cover is rotated clockwise from the minimum torsion gear, the torsional cover drives the adjusting screws to slide downward to compress the compression springs; and when the torsional cover is rotated anticlockwise from the minimum torsion gear, the torsional cover locks the tripping cushion on the front gearbox housing through the cushion locking structure.

Limiting chutes which extend along the vertical direction are formed at the top of the front gearbox housing along the circumference. Limiting projections correspondingly matched with the limiting chutes are disposed towards the inner side of the tripping cushion in a projecting way. The limiting projections are disposed in the corresponding limiting chutes in a sliding way along the vertical direction. A lock groove correspondingly matched with a corresponding limiting projection is circumferentially formed on the anticlockwise side of each limiting chute. A pulling projection is disposed outward in a projecting way at the outer side of the tripping cushion. A tripping drive block corresponding to the pulling projection is disposed in a projecting way at the inner side of the torsional cove. When the torsional cover is rotated anticlockwise from the minimum torsion gear, the tripping drive module of the torsional cover pushes the pulling projection of the tripping cushion, driving the tripping cushion to rotate anticlockwise such that the limiting projections are clamped in the lock grooves.

A tripping reset spring is connected between the tripping cushion and the front gearbox housing.

The upper end of each tripping column passes each corresponding adjusting screw in a sliding way to be pressed against the lower end face of the tripping cushion.

Through-holes through which the tripping columns pass are respectively formed at positions, corresponding to the tripping columns, on the tripping cushion.

An output shaft penetrates the front gearbox housing. The bottom of the output shaft is connected with the reduction mechanism. The output shaft is sleeved with an impact mechanism and an impact conversion cushion. The impact conversion cushion extends outward in a projecting way to form an impact conversion shift lever. A step slot is axially formed on the outer side of the top of the front gearbox housing. The impact conversion shift lever is located at the position of a step in the step slot. An impact conversion drive block corresponding to the impact conversion shift lever is disposed in a projecting way at the inner side of the torsional cover. When the torsional cover is rotated anticlockwise by a proper angle from the minimum torsion gear and then continuously rotated anticlockwise, the impact conversion drive block of the torsional cover pushes the impact conversion shift lever of the impact conversion cushion, driving the impact conversion cushion to rotate anticlockwise such that the impact conversion shift lever rotates to the position of a slot bottom of the step slot.

An impact conversion reset spring is connected between the impact conversion cushion and the front gearbox housing.

The present invention has the following beneficial effects: The gear adjusting device for a gearbox of an impact drill provided by the present invention includes the front gearbox housing, the torsional cover, the reduction mechanism and the tripping mechanism; the tripping mechanism includes the annular adjusting screws, the tripping columns and the tripping cushion; each tripping column is sleeved with the compression spring; two ends of each compression spring are respectively connected to the bottom of each corresponding adjusting screw and each corresponding tripping column; the torsional cover is in threaded drive connection with each adjusting screw; the lower end of each tripping column is connected with the reduction mechanism; the tripping cushion is connected to the front gearbox housing in a sliding way along the vertical direction; the cushion locking structure capable of locking the tripping cushion is disposed between the torsional cover and the front gearbox housing. When the torsional cover is rotated clockwise from the minimum torsion gear, the torsional cover drives the adjusting screws to slide downward to compress the compression springs; and when the torsional cover is rotated anticlockwise from the minimum torsion gear, the torsional cover locks the tripping cushion on the front gearbox housing through the cushion locking structure. When it is needed to switch to the electric drill function, the tripping cushion can be locked and fixed through the cushion locking structure as long as the torsional cover is rotated anticlockwise, so that the tripping cushion cannot move up and down to conduct the electric drill function. The gear adjusting device of the present invention can quickly adjust the gear shift to the electric drill or impact gear; the adjusting stroke is very small; the operation is simple and convenient; and the efficiency is high.

### BRIEF DESCRIPTION OF THE SEVERAL VIEWS OF THE DRAWINGS

FIG. 1 is a structural view of the present invention.

FIG. 2 is a sectional view of the present invention.

FIG. 3 is an exploded view of the present invention.

FIG. 4 is a structural view of a torsional cover of the present invention.

FIG. 5 is a structural view of a front gearbox housing of the present invention.

FIG. 6 is a structural view of a tripping cushion according to another embodiment of the present invention.

### DETAILED DESCRIPTION OF THE INVENTION

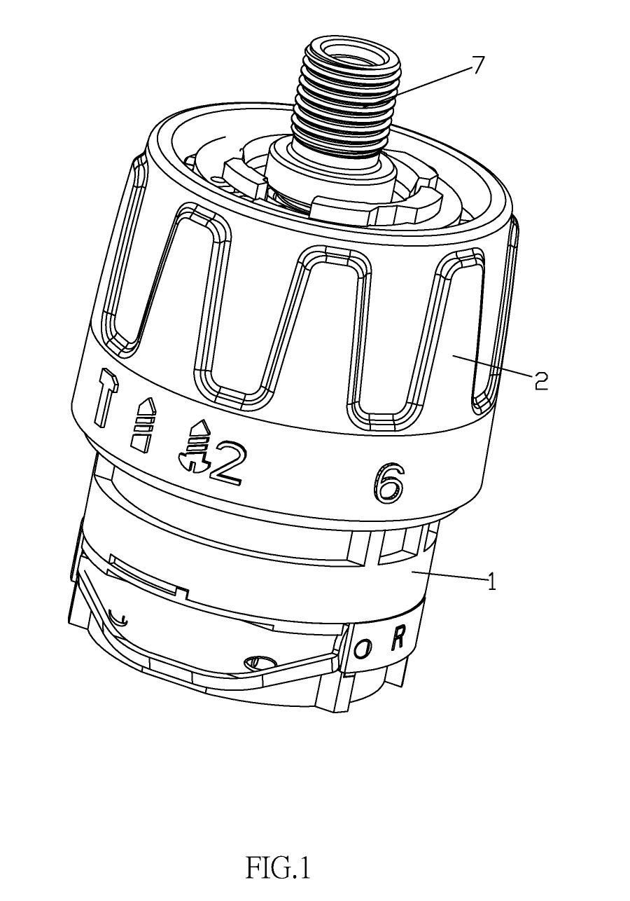

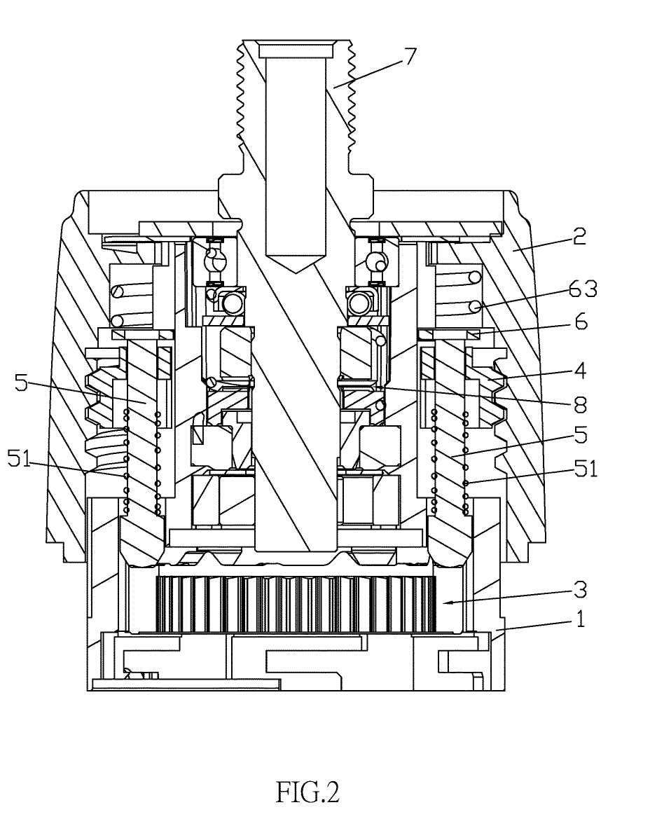

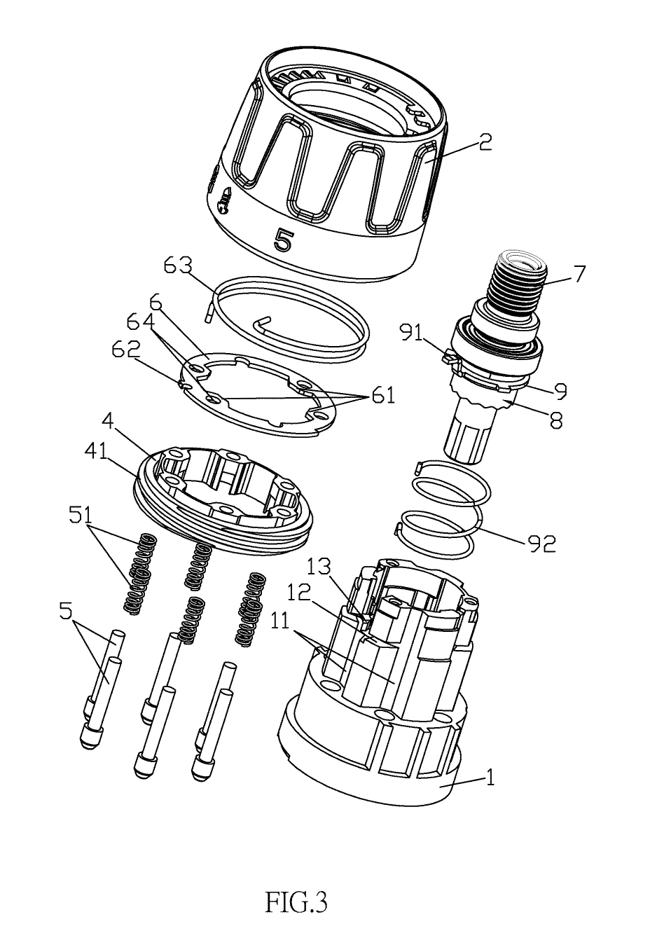

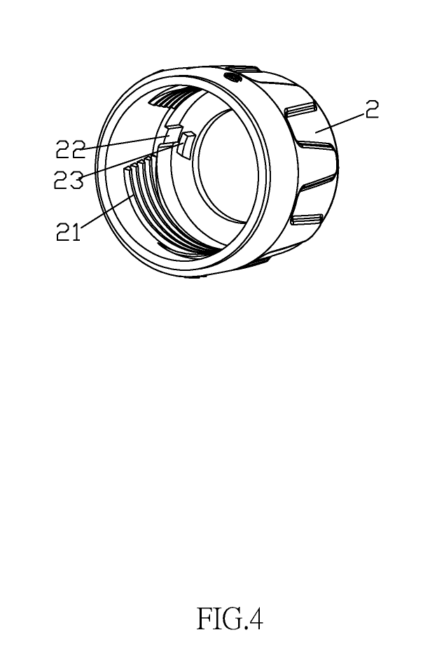

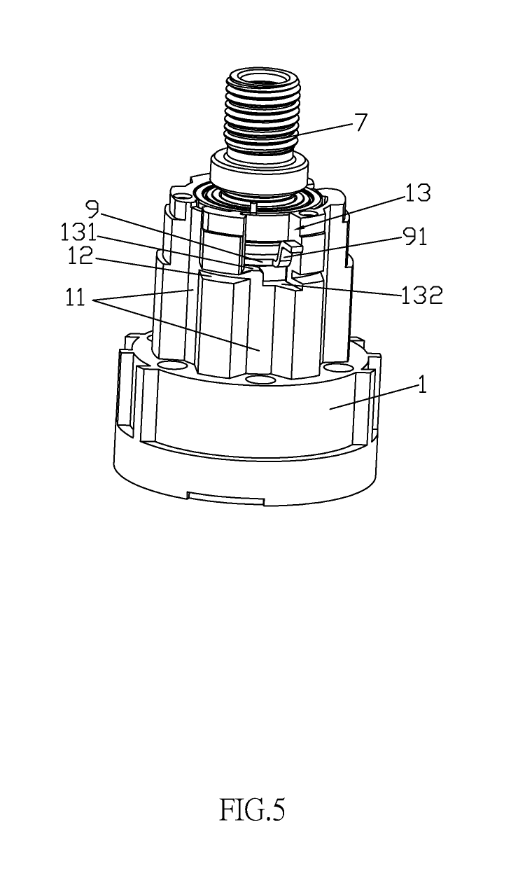

The present invention is further described in conjunction with the attached drawings. See FIGS. 1-6. A gear adjusting device for a gearbox of an impact drill of the present invention includes a front gearbox housing 1, a torsional cover 2 rotationally sleeved at the top of the front gearbox housing 1, a reduction mechanism 3 disposed at the bottom of the front gearbox housing 1 and a tripping mechanism. The tripping mechanism comprises annular adjusting screws 4 which are sleeved on the front gearbox housing 1 in a sliding way along the vertical direction, a plurality of tripping columns 5 which are connected to the front gearbox housing 1 in a sliding way along the vertical direction, and a tripping cushion 6 positioned above the adjusting screws 4 and the tripping columns 5. Each tripping column 5 is sleeved with a compression spring 51; two ends of each compression spring 51 are respectively connected to the bottom of each corresponding adjusting screw 4 and each corresponding tripping column 5. External screw threads 41 are formed on the outside surface of each adjusting screw 4; internal screw threads 21 are formed on the inside surface of the torsional cover 2; the internal screw threads 21 of the torsional cover 2 are in threaded drive connection with the external screw threads 41 of each adjusting screw 4. The lower end of each tripping column 5 is connected with the reduction mechanism 3. The tripping cushion 6 is connected to the front gearbox housing 1 in a sliding way along the vertical direction.

A cushion locking structure capable of locking the tripping cushion 6 is disposed between the torsional cover 2 and the front gearbox housing 1. When the torsional cover 2 is rotated clockwise from the minimum torsion gear, the torsional cover 2 drives the adjusting screws 4 to slide downward to compress the compression springs 51. The torsional cover 2 adjusts the pressure applied by the tripping columns 5 to a wheel gear in the reduction mechanism 3 by adjusting the compression quantity of the adjusting screws 51, and when the gearbox of the impact drill trips, the tripping cushion 6 moves up and down along with the tripping columns 5. When the torsional cover 2 is rotated anticlockwise from the minimum torsion gear, the torsional cover 2 locks the tripping cushion 6 on the front gearbox housing 1 through the cushion locking structure. When it is needed to switch to the electric drill function, the tripping cushion 6 can be locked and fixed through the cushion locking structure as long as the torsional cover 2 is rotated anticlockwise, so that the tripping cushion cannot move up and down to conduct the electric drill function. The gear adjusting device of the present invention can quickly adjust the gear shift to the electric drill or impact gear; the adjusting stroke is very small; the operation is simple and convenient; and the efficiency is high.

Limiting chutes 11 which extend along the vertical direction are formed at the top of the front gearbox housing 1 along the circumference. Limiting projections 61 correspondingly matched with the limiting chutes 11 are disposed towards the inner side of the tripping cushion 6 in a projecting way. The limiting projections 61 are disposed in the corresponding limiting chutes 11 in a sliding way along the vertical direction. A lock groove 12 correspondingly matched with a corresponding limiting projection 61 is circumferentially formed on the anticlockwise side of each limiting chute 11. A pulling projection 62 is disposed outward in a projecting way at the outer side of the tripping cushion 6. A tripping drive block 22 corresponding to the pulling projection 62 is disposed in a projecting way at the inner side of the torsional cover 2. When the torsional cover 2 is rotated anticlockwise from the minimum torsion gear, the tripping drive module 22 of the torsional cover 2 pushes the pulling projection 62 of the tripping cushion 6, driving the tripping cushion 6 to rotate anticlockwise such that the limiting projections 61 are clamped in the lock grooves 12. The limiting projections 61, the limiting chutes 11, the pulling projection 62 and the tripping drive block 22 constitute the cushion locking structure which is simple and conveniently operated. A tripping reset spring 63 is connected between the tripping cushion 6 and the front gearbox housing 1. When the torsional cover 2 is rotated back to a screw gear, the tripping cushion 6 resets automatically by the effect of the tripping reset spring 63.

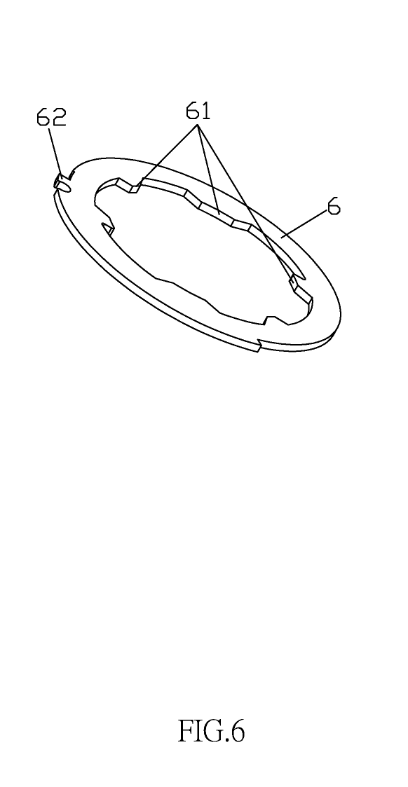

The upper end of each tripping column 5 passes each corresponding adjusting screw 4 in a sliding way to be pressed against the lower end face of the tripping cushion 6. Through-holes 64 through which the tripping columns 5 pass are respectively formed at positions, corresponding to the tripping columns 5, on the tripping cushion 6. At the screw gear, each tripping column 5 moves up and down through the corresponding through-hole 64 on the tripping cushion 6, and the tripping cushion 6 does not move. At the electric drill gear and the impact gear, the tripping cushion 6 is driven to rotate by the torsional cover 2 to be clamped in the front gearbox housing 1. At the same time, the through-holes 64 on the tripping cushion 6 are staggered with the tripping columns 5 to press the tripping columns 5 such that the tripping columns 5 cannot move up and down, realizing the electric drill and impact functions. As shown in FIG. 6, the position, corresponding to each tripping column 5, on the tripping cushion 6 can be an entity structure, and at the screw gear, the tripping columns 5 jack up the tripping cushion 6 to drive the tripping cushion 6 to move up and down.

An output shaft 7 penetrates the front gearbox housing 1. The bottom of the output shaft 7 is connected with the reduction mechanism 3. The output shaft 7 is sleeved with an impact mechanism 8 and an impact conversion cushion 9. The impact conversion cushion 9 extends outward in a projecting way to form an impact conversion shift lever 91. A step slot 13 is axially formed on the outer side of the top of the front gearbox housing 1. The impact conversion shift lever 91 is located at the position of a step 131 in the step slot 13. Blocked by the step 131 of the step slot 13, the impact conversion shift lever 91 cannot move up and down. An impact conversion drive block 23 corresponding to the impact conversion shift lever 91 is disposed in a projecting way at the inner side of the torsional cover 2. When the torsional cover 2 is rotated anticlockwise by a proper angle from the minimum torsion gear and then continuously rotated anticlockwise, the impact conversion drive block 23 of the torsional cover 2 pushes the impact conversion shift lever 91 of the impact conversion cushion 9, driving the impact conversion cushion 9 to rotate anticlockwise such that the impact conversion shift lever 91 rotates to the position of a slot bottom 132 of the step slot 13. The impact conversion shift lever 91 has a space for moving up and down, so the impact mechanism 8 can drive the output shaft 7 to move up and down to realize the impact function, which means that, when the gear shift is switched to the impact gear, the torsional cover 2 drives the tripping cushion 6 to rotate and also drives the impact conversion cushion 9 to realize the impact function. An impact conversion reset spring 92 is connected between the impact conversion cushion 9 and the front gearbox housing 1. When the gear shift is adjusted to the electric drill gear or the screw gear, the impact conversion cushion 9 resets automatically by the effect of the impact conversion reset spring 92.

The above embodiments are merely preferably embodiments of the present invention. Therefore, equivalent variations or modifications made on the basis of the structure, characteristics and principle in the scope of the patent application of the present invention shall fall within the application scope of the present invention.

What is claimed is:

1. A gear adjusting device for a gearbox of an impact drill, comprising a front gearbox housing (1), a torsional cover (2) rotationally sleeved at the top of the front gearbox housing (1), a reduction mechanism (3) disposed at the bottom of the front gearbox housing (1) and a tripping mechanism, characterized in that, the tripping mechanism comprises annular adjusting screws (4) which are sleeved on the front gearbox housing (1) in a sliding way along the vertical direction, a plurality of tripping columns (5) which are connected to the front gearbox housing (1) in a sliding way along the vertical direction, and a tripping cushion (6) positioned above the adjusting screws (4) and the tripping columns (5); each tripping column (5) is sleeved with a compression spring (51); two ends of each compression spring (51) are respectively connected to the bottom of each corresponding adjusting screw (4) and each corresponding tripping column (5); external screw threads (41) are formed on the outside surface of each adjusting screw (4); internal screw threads (21) are formed on the inside surface of the torsional cover (2); the internal screw threads (21) of the torsional cover (2) are in threaded drive connection with the external screw threads (41) of each adjusting screw (4); the lower end of each tripping column (5) is connected with the reduction mechanism (3); the tripping cushion (6) is connected to the front gearbox housing (1) in a sliding way along the vertical direction; a cushion locking structure capable of locking tripping cushion (6) is disposed between the torsional cover (2) and the front gearbox housing (1); when the torsional cover (2) is rotated clockwise from the minimum torsion gear, the torsional cover (2) drives the adjusting screws (4) to slide downward to compress the compression springs (51); and when the torsional cover (2) is rotated anticlockwise from the minimum torsion gear, the torsional cover (2) locks the tripping cushion (6) on the front gearbox housing (1) through the cushion locking structure.

2. The gear adjusting device for a gearbox of an impact drill according to claim 1, characterized in that limiting chutes (11) which extend along the vertical direction are formed at the top of the front gearbox housing (1) along the circumference; limiting projections (61) correspondingly matched with the limiting chutes (11) are disposed towards the inner side of the tripping cushion (6) in a projecting way; the limiting projections (61) are disposed in the corresponding limiting chutes (11) in a sliding way along the vertical direction; a lock groove (12) correspondingly matched with a corresponding limiting projection (61) is circumferentially formed on the anticlockwise side of each limiting chute (11); a pulling projection (62) is disposed outward in a projecting way at the outer side of the tripping cushion (6); a tripping drive block (22) corresponding to the pulling projection (62) is disposed in a projecting way at the inner side of the torsional cover (2); when the torsional cover (2) is rotated anticlockwise from the minimum torsion gear, the tripping drive module (22) of the torsional cover (2) pushes the pulling projection (62) of the tripping cushion (6), driving the tripping cushion (6) to rotate anticlockwise such that the limiting projections (61) are clamped in the lock grooves (12).

3. The gear adjusting device for a gearbox of an impact drill according to claim 2, characterized in that a tripping reset spring (63) is connected between the tripping cushion (6) and the front gearbox housing (1).

4. The gear adjusting device for a gearbox of an impact drill according to claim 2, characterized in that the upper end of each tripping column (5) passes each corresponding adjusting screw (4) in a sliding way to be pressed against the lower end face of the tripping cushion (6).

5. The gear adjusting device for a gearbox of an impact drill according to claim 1, characterized in that through-holes (64) through which tripping columns (5) pass are respectively formed at positions, corresponding to the tripping columns (5), on the tripping cushion (6).

6. The gear adjusting device for a gearbox of an impact drill according to claim 1, characterized in that an output shaft (7) penetrates the front gearbox housing (1); the bottom of the output shaft (7) is connected with the reduction mechanism (3); the output shaft (7) is sleeved with an impact mechanism (8) and an impact conversion cushion (9); the impact conversion cushion (9) extends outward in a projecting way to form an impact conversion shift lever (91); a step slot (13) is axially formed on the outer side of the top of the front gearbox housing (1); the impact conversion shift lever (91) is located at the position of a step (131) in the step slot (13); an impact conversion drive block (23) corresponding to the impact conversion shift lever (91) is disposed in a projecting way at the inner side of the torsional cover (2); when the torsional cover (2) is rotated by a proper angle from the minimum torsion gear and then continuously rotated anticlockwise, the impact conversion drive block (23) of the torsional cover (2) pushes the impact conversion shift lever (91) of the impact conversion cushion (9), driving the impact conversion cushion (9) to rotate anticlockwise such that the impact conversion shift lever (91) rotates to the position of a slot bottom (132) of the step slot (13).

7. The gear adjusting device for a gearbox of an impact drill according to claim 6, characterized in that an impact conversion reset spring (92) is connected between the impact conversion cushion (9) and the front gearbox housing (1).

8. The gear adjusting device for a gearbox of an impact drill according to claim 2, characterized in that an output shaft (7) penetrates the front gearbox housing (1); the bottom of the output shaft (7) is connected with the reduction mechanism (3); the output shaft (7) is sleeved with an impact mechanism (8) and an impact conversion cushion (9); the impact conversion cushion (9) extends outward in a projecting way to form an impact conversion shift lever (91); a step slot (13) is axially formed on the outer side of the top of the front gearbox housing (1); the impact conversion shift lever (91) is located at the position of a step (131) in the step slot (13); an impact conversion drive block (23) corresponding to the impact conversion shift lever (91) is disposed in a projecting way at the inner side of the torsional cover (2); when the torsional cover (2) is rotated by a proper angle from the minimum torsion gear and then continuously rotated anticlockwise, the impact conversion drive block (23) of the torsional cover (2) pushes the impact conversion shift lever (91) of the impact conversion cushion (9), driving the impact conversion cushion (9) to rotate anticlockwise such that the impact conversion shift lever (91) rotates to the position of a slot bottom (132) of the step slot (13).

9. The gear adjusting device for a gearbox of an impact drill according to claim 8, characterized in that an impact conversion reset spring (92) is connected between the impact conversion cushion (9) and the front gearbox housing (1).

10. The gear adjusting device for a gearbox of an impact drill according to claim 3, characterized in that an output shaft (7) penetrates the front gearbox housing (1); the bottom of the output shaft (7) is connected with the reduction mechanism (3); the output shaft (7) is sleeved with an impact mechanism (8) and an impact conversion cushion (9); the impact conversion cushion (9) extends outward in a projecting way to form an impact conversion shift lever (91); a step slot (13) is axially formed on the outer side of the top of the front gearbox housing (1); the impact conversion shift lever (91) is located at the position of a step (131) in the step slot (13); an impact conversion drive block (23) corresponding to the impact conversion shift lever (91) is disposed in a projecting way at the inner side of the torsional cover (2); when the torsional cover (2) is rotated by a proper angle from the minimum torsion gear and then continuously rotated anticlockwise, the impact conversion drive block (23) of the torsional cover (2) pushes the impact conversion shift lever (91) of the impact conversion cushion (9), driving the impact conversion cushion (9) to rotate anticlockwise such that the impact conversion shift lever (91) rotates to the position of a slot bottom (132) of the step slot (13).

11. The gear adjusting device for a gearbox of an impact drill according to claim 10, characterized in that an impact conversion reset spring (92) is connected between the impact conversion cushion (9) and the front gearbox housing (1).

12. The gear adjusting device for a gearbox of an impact drill according to claim 4, characterized in that an output shaft (7) penetrates the front gearbox housing (1); the bottom of the output shaft (7) is connected with the reduction mechanism (3); the output shaft (7) is sleeved with an impact mechanism (8) and an impact conversion cushion (9); the impact conversion cushion (9) extends outward in a projecting way to form an impact conversion shift lever (91); a step slot (13) is axially formed on the outer side of the top of the front gearbox housing (1); the impact conversion shift lever (91) is located at the position of a step (131) in the step slot (13); an impact conversion drive block (23) corresponding to the impact conversion shift lever (91) is disposed in a projecting way at the inner side of the torsional cover (2); when the torsional cover (2) is rotated by a proper angle from the minimum torsion gear and then continuously rotated anticlockwise, the impact conversion drive block (23) of the torsional cover (2) pushes the impact conversion shift lever (91) of the impact conversion cushion (9), driving the impact conversion cushion (9) to rotate anticlockwise such that the impact conversion shift lever (91) rotates to the position of a slot bottom (132) of the step slot (13).

13. The gear adjusting device for a gearbox of an impact drill according to claim 12, characterized in that an impact conversion reset spring (92) is connected between the impact conversion cushion (9) and the front gearbox housing (1).

14. The gear adjusting device for a gearbox of an impact drill according to claim 5, characterized in that an output shaft (7) penetrates the front gearbox housing (1); the bottom of the output shaft (7) is connected with the reduction mechanism (3); the output shaft (7) is sleeved with an impact mechanism (8) and an impact conversion cushion (9); the impact conversion cushion (9) extends outward in a projecting way to form an impact conversion shift lever (91); a step slot (13) is axially formed on the outer side of the top of the front gearbox housing (1); the impact conversion shift lever (91) is located at the position of a step (131) in the step slot (13); an impact conversion drive block (23) corresponding to the impact conversion shift lever (91) is disposed in a projecting way at the inner side of the torsional cover (2); when the torsional cover (2) is rotated by a proper angle from the minimum torsion gear and then continuously rotated anticlockwise, the impact conversion drive block (23) of the torsional cover (2) pushes the impact conversion shift lever (91) of the impact conversion cushion (9), driving the impact conversion cushion (9) to rotate anticlockwise such that the impact conversion shift lever (91) rotates to the position of a slot bottom (132) of the step slot (13).

15. The gear adjusting device for a gearbox of an impact drill according to claim 14, characterized in that an impact conversion reset spring (92) is connected between the impact conversion cushion (9) and the front gearbox housing (1).
